(19) United States
(12) Patent Application Publication
(10) Pub. No.: US 2024/0392994 A1
(43) Pub. Date: Nov. 28, 2024

(54) ENVIRONMENTAL CONDITION-BASED WORKSPACE ASSIGNMENT

(71) Applicant: International Business Machines Corporation, Armonk, NY (US)

(72) Inventors: Ajit Jariwala, Cary, NC (US); Eric B. Libow, Raleigh, NC (US); Jackson P Leonard, Austin, TX (US); Thomas Scott Wallace, Hillsborough, NC (US)

(73) Assignee: International Business Machines Corporation, Armonk, NY (US)

(21) Appl. No.: 18/200,177

(22) Filed: May 22, 2023

(51) Int. Cl. F24F 11/64; G05B 19/042; G06Q 10/02

(52) U.S. Cl. CPC F24F 11/64; G05B 19/042; G06Q 10/02; G05B 2219/2614

(57) ABSTRACT

A workspace is assigned according to a temperature preference, for a time period. The temperature preference and the time period are specified in a workspace booking request. Using a building management system, an ambient temperature of the workspace is adjusted during the time period. The adjusting results in the ambient temperature matching, within a threshold amount, the temperature preference.

### BACKGROUND

The present invention relates generally to a method, system, and computer program product for building heating, ventilation, and air conditioning (HVAC) management. More particularly, the present invention relates to a method, system, and computer program product for environmental condition-based workspace assignment.

HVAC management is the use of technologies to control the temperature, humidity, and other environmental conditions in an enclosed space such as a building, to provide thermal comfort and acceptable indoor air quality. In many implementations, a building management system performs HVAC management as well as other building management tasks such as lighting and access management.

### SUMMARY

The illustrative embodiments provide a method, system, and computer program product. An embodiment includes a method that assigns, according to a temperature preference, for a time period, a workspace, the temperature preference and the time period specified in a workspace booking request. An embodiment adjusts, using a building management system, during the time period, an ambient temperature of the workspace, the adjusting resulting in the ambient temperature matching, within a threshold amount, the temperature preference.

An embodiment includes a computer-usable program product. The computer-usable program product includes one or more computer-readable storage devices, and program instructions stored on at least one of the one or more storage devices.

An embodiment includes a computer system. The computer system includes one or more processors, one or more computer-readable memories, one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts an example diagram of a data processing environment in which illustrative embodiments may be implemented;

FIG. 2 depicts a block diagram of an example configuration for environmental condition based workspace assignment in accordance with an illustrative embodiment;

FIG. 3 depicts an example of environmental condition based workspace assignment in accordance with an illustrative embodiment;

FIG. 4 depicts a continued example of environmental condition based workspace assignment in accordance with an illustrative embodiment;

FIG. 5 depicts a continued example of environmental condition based workspace assignment in accordance with an illustrative embodiment;

FIG. 6 depicts a flowchart of an example process for environmental condition based workspace assignment in accordance with an illustrative embodiment.

### DETAILED DESCRIPTION

The illustrative embodiments recognize that many offices and other areas where people work do not have permanent seating arrangements. Instead, users reserve a workspace, such as a desk or a conference room, in advance or when they arrive at the workspace. Some users have specific requirements for their workspaces. For example, a software developer might want a workspace with two large display screens, a stock trader might want a workspace with six display screens and a hardwired network connection with at least a specified speed, or a team working on a secret project might want a conference room with a solid door, no windows, enough chairs for the team, and a whiteboard. Users also have preferences for their workspaces. For example, one user might want to be near other members of her team, another user might prefer a quiet area with few other people nearby, and a third user might prefer a workspace near a window. Users also have environmental condition preferences for their workspaces. For example, one user might prefer a temperature in the 70-72° F. range, while another user might prefer a temperature in the 76-78° F. range. Hence, the illustrative embodiments recognize that there is a need to improve users' experiences with a workspace by taking environmental condition preferences into account when assigning workspaces. The illustrative embodiments also recognize that knowledge of environmental conditions within a building, such as natural lighting, natural heating, and cooling (because hot air rises and cool air falls), and hotter-than-average (e.g., near a server room) and cooler-than-average (e.g., near an air conditioning vent) areas, can be used in suggesting workspace options and assigning workspaces to a user, thus potentially reducing a building's energy usage.

The illustrative embodiments recognize that the presently available tools or solutions do not address these needs or provide adequate solutions for these needs. The illustrative embodiments used to describe the invention generally address and solve the above-described problems and other problems related to environmental condition-based workspace assignment.

An embodiment can be implemented as a software application. The application implementing an embodiment can be configured as a modification of an existing building or HVAC management system, as a separate application that operates in conjunction with an existing building or HVAC management system, as a standalone application, or some combination thereof.

Particularly, some illustrative embodiments provide a method that assigns, according to a temperature preference, for a time period, a workspace, the temperature preference and the time period specified in a workspace booking request; and adjusts, using a building management system, during the time period, an ambient temperature of the workspace, the ambient temperature matching, within a threshold amount, the temperature preference.

An embodiment generates a user profile from user profile data, both received and learned from usage data accumulated as the user uses an embodiment. Some non-limiting examples of received user profile data are a user's account credentials, human resources data of a user (e.g., a user's role, group, assigned project, manager, assigned work schedule, and the like), and the user's temperature preference. Some non-limiting examples of usage data accumulated as the user uses an embodiment are a user's previous workspace reservation data, the workspaces or types of workspaces a user requests or chooses most frequently, the other people a user requests proximity to, the equipment a user requests that a workspace contain, and the like. An embodiment uses a presently available technique, such as a machine learning model, to combine received user profile data with usage data accumulated as the user uses an embodiment and derives one or more usage patterns for a user. For example, one user might have a usage pattern of being in the office Tuesday-Thursday, 10 am-7 pm, reserving a workspace with two large display screens, near a window, and with a temperature preference of 70-72° F. Another example group of users might reserve the same enclosed conference room for one week at the beginning of every quarter, and have temperature preferences in the 70-75° F. range.

An embodiment generates a building profile from building profile data, both received and learned from usage data accumulated as a building management system manages environmental conditions within a building to conform to users' requested workspace environmental preferences. Some non-limiting examples of received building profile data are the locations of workspaces within a building, equipment located in particular workspaces, the locations of elevators, stairs, restrooms, snack stations, and other amenities, the locations and exposures of windows and doors, and the like. Some non-limiting examples of building profile data learned from usage data accumulated as a building management system manage environmental conditions within a building including temperature and heating and cooling patterns within portions of a building, depending on the outside temperature and outside weather conditions. For example, a south-facing workspace with a wall of windows facing south or west is likely to be warmer on a sunny day than a cloudy day, due to natural solar heating. An embodiment uses a presently available technique, such as a machine learning model, to combine received building profile data with usage data accumulated as a building management system manages environmental conditions within a building and derives one or more anticipated ambient temperatures, building usage patterns, and temperature gradients within a building under different weather conditions. An embodiment uses building usage patterns and temperature gradients to anticipate heating and cooling needs for portions of a building and assign users to workspaces accordingly.

An embodiment receives a workspace booking request for a user. A workspace booking request is a request to book a workspace within a plurality of workspaces available to the user. The workspace booking request includes a requested time period, either explicitly provided in the workspace booking request or extracted from the user's profile (e.g., using the user's previously requested or booked time periods, or the user's work schedule). The workspace booking request includes a location, either explicitly provided in the workspace booking request or extracted from the user's profile (e.g., using the user's previously requested or booked building or workspace locations). The workspace booking request includes a temperature preference, either explicitly provided in the workspace booking request or extracted from the user's profile. The workspace booking request also, optionally, includes other elements explicitly provided in the workspace booking request or extracted from the user's profile, such as a user's equipment requirements or preferences, other people a user requests proximity to in this request, or typically requests proximity to, a type of workspace a user has previously requested or has chosen most frequently, and the like.

An embodiment assigns a workspace according to the temperature preference in the workspace booking request, as well as other preferences or requirements in the workspace booking request. One embodiment also assigns a workspace according to a user's past workspace booking request(s). Another embodiment also assigns a workspace according to a user's equipment requirements or preferences. Another embodiment also assigns a workspace according to the workspace requests or assigned workspaces of other people a user requested proximity to or typically requests proximity to. Another embodiment also assigns a workspace according to the type of workspace a user has previously requested or has chosen most frequently. An embodiment uses a building management system to measure an ambient temperature of the workspace and adjust an ambient temperature of the workspace during the time period specified in one or more workspace assignments.

For example, consider User A's request for a workspace for Monday all day. User A prefers a temperature range of 70-72° F. and does not require any other equipment or proximity to co-workers. An embodiment knows from the building profile, that area 101 of Floor 1 has an ambient temperature in the 70-72° F. range and thus assigns User A to a workspace in area 101 of Floor 1.

As another example, consider User B's request for a workspace for Monday all day. User B prefers a temperature range of 74-76° F. and does not require any other equipment or proximity to co-workers. Because area 101 of Floor 1 has an ambient temperature in the 70-72° F. range and hot air rises, it will be efficient to set area 201 of Floor 2, directly above area 101 of Floor 1, to 74-76° F. Thus, the embodiment assigns User B to a workspace in area 201 of Floor 2 and adjusts an ambient temperature of the workspace to 74-76° F. all day on Monday.

As another example, consider Users C, D, and E, a team requesting workspaces for Monday afternoon, near each other and near User B. The team prefers a combined temperature range of 70-74° F., obtained by averaging each member's temperature preferences, taking the union of each member's temperature preferences, taking the intersection of each member's temperature preferences, or using another presently available method of combining temperature ranges. Because area 201 of Floor 2, where User B will be, is already set to an ambient temperature of 74-76° F. all day on Monday, an embodiment assigns Users C. D. and E to workspaces in area 202 of Floor 2, next to area 201, and adjusts an ambient temperature of the workspaces to 74° F. (thus satisfying Users C. D, and E while not discommoding User B and other users who prefer the 74-76° F. of nearby workspaces).

An embodiment uses workspace booking requests and a building management system to minimize adjustments to an ambient temperature of workspaces within a building. For example, natural heating due to the sun or rising heat might mean that an upper floor is naturally warmer than a lower floor of a building, and thus an embodiment might assign those who prefer a warmer environment to the upper floor and those who prefer a cooler environment to the lower floor. As another example, natural heating due to the sun might mean that a building area exposed to the sun is naturally warmer than a building area that is not exposed to the sun, and thus an embodiment might assign those who prefer a warmer environment to the sunny area, during times when the area is exposed to the most sunlight, and those who prefer a cooler environment to an area exposed to less sunlight, and adjust workspace assignment according to the sun's movement during the day. As another example, if there are fewer workspace requests than workspaces in a building, an embodiment might group the assigned workspaces into one area of a building, and adjust ambient temperatures in unoccupied portions of the building to temperatures lower-than-preferred (in the winter) or higher-than-preferred (in the summer) to conserve energy.

The manner of environmental condition-based workspace assignment described herein is unavailable in the presently available methods in the technological field of endeavor pertaining to automated building management. A method of an embodiment described herein, when implemented to execute on a device or data processing system, comprises substantial advancement of the functionality of that device or data processing system in assigning, according to a temperature preference, for a time period, a workspace, the temperature preference and the time period specified in a workspace booking request; and adjusting, using a building management system, during the time period, an ambient temperature of the workspace, the ambient temperature matching, within a threshold amount, the temperature preference.

The illustrative embodiments are described with respect to certain types of user profiles, building profiles, building usage patterns, workspaces, workspace booking requests, temperature preferences, temperature ranges, time periods, forecasts, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limited to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures, therefore, may be used in conjunction with such embodiment of the invention within the scope of the invention. An illustrative embodiment may be implemented in hardware, software, or a combination thereof.

The examples in this disclosure are used only for the clarity of the description and are not limited to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limited to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description of cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

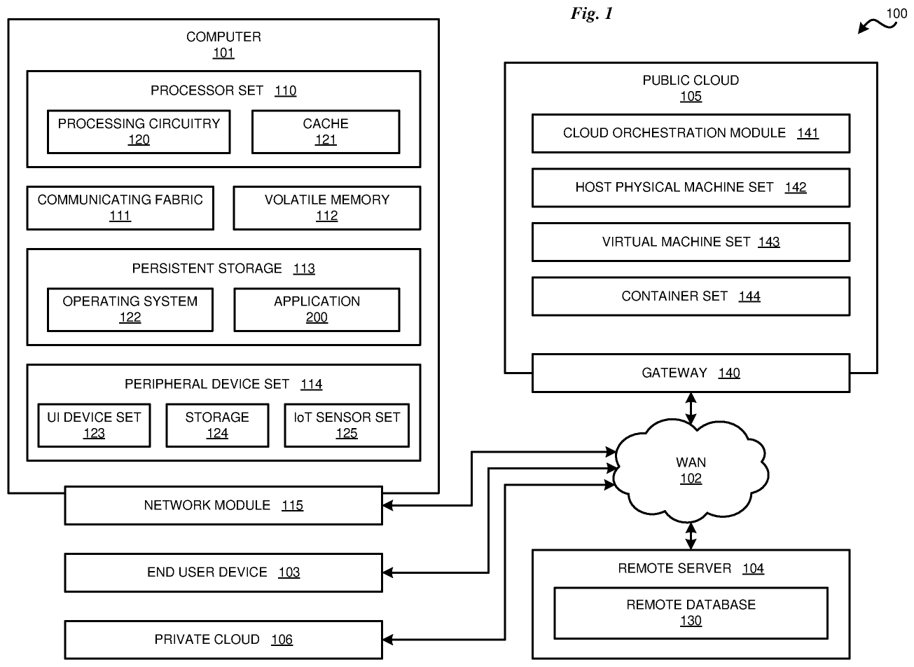

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description. FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements an environmental condition based workspace assignment embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single- or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IoT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way. EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

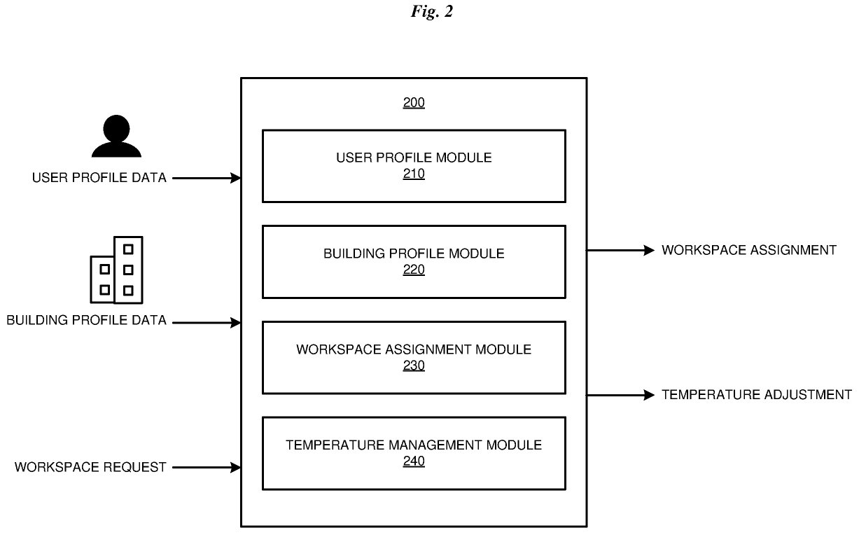

With reference to FIG. 2, this figure depicts a block diagram of an example configuration for environmental condition based workspace assignment in accordance with an illustrative embodiment. Application 200 is the same as application 200 in FIG. 1.

User profile module 210 generates a user profile from user profile data, both received and learned from usage data accumulated as the user uses application 200. Some non-limiting examples of received user profile data are a user's account credentials, human resources data of a user (e.g., a user's role, group, assigned project, manager, assigned work schedule, and the like), and the user's temperature preference. Some non-limiting examples of usage data accumulated as the user uses application 200 are a user's previous workspace reservation data, the workspaces or types of workspaces a user requests or chooses most frequently, the other people a user requests proximity to, the equipment a user requests that a workspace contain, and the like. Module 210 uses a presently available technique, such as a machine learning model, to combine received user profile data with usage data accumulated as the user uses application 200 and derive one or more usage patterns for a user. For example, one user might have a usage pattern of being in the office Tuesday-Thursday, 10 am-7 pm, reserving a workspace with two large display screens, near a window, and with a temperature preference of 70-72° F. Another example group of users might reserve the same enclosed conference room for one week at the beginning of every quarter, and have temperature preferences in the 70-75° F. range.

Building profile module 220 generates a building profile from building profile data, both received and learned from usage data accumulated as a building management system manages environmental conditions within a building to conform to users' requested workspace environmental preferences. Some non-limiting examples of received building profile data are the locations of workspaces within a building, equipment located in particular workspaces, the locations of elevators, stairs, restrooms, snack stations, and other amenities, the locations and exposures of windows and doors, and the like. Some non-limiting examples of building profile data learned from usage data accumulated as a building management system manages environmental conditions within a building include temperature and heating and cooling patterns within portions of a building, depending on the outside temperature and outside weather conditions. For example, a south facing workspace with a wall of windows facing south or west is likely to be warmer on a sunny day than a cloudy day, due to natural solar heating. Module 220 uses a presently available technique, such as a machine learning model, to combine received building profile data with usage data accumulated as a building management system manages environmental conditions within a building and derive one or more anticipated ambient temperatures, building usage patterns, and temperature gradients within a building under different weather conditions. Module 220 uses building usage patterns and temperature gradients to anticipate heating and cooling needs for portions of a building and assign users to workspaces accordingly.

Workspace assignment module 230 receives a workspace booking request for a user. A workspace booking request is a request to book a workspace within a plurality of workspaces available to the user. The workspace booking request includes a requested time period, either explicitly provided in the workspace booking request or extracted from the user's profile (e.g., using the user's previously requested or booked time periods, or the user's work schedule). The workspace booking request includes a location, either explicitly provided in the workspace booking request or extracted from the user's profile (e.g., using the user's previously requested or booked building or workspace locations). The workspace booking request includes a temperature preference, either explicitly provided in the workspace booking request or extracted from the user's profile. The workspace booking request also, optionally, includes other elements explicitly provided in the workspace booking request or extracted from the user's profile, such as a user's equipment requirements or preferences, other people a user requests proximity to in this request or typically requests proximity to, a type of workspace a user has previously requested or has chosen most frequently, and the like.

Workspace assignment module 230 assigns a workspace according to the temperature preference in the workspace booking request, as well as other preferences or requirements in the workspace booking request. One implementation of module 230 also assigns a workspace according to a user's past workspace booking request(s). Another implementation of module 230 also assigns a workspace according to a user's equipment requirements or preferences. Another implementation of module 230 also assigns a workspace according to the workspace requests or assigned workspaces of other people a user requested proximity to or typically requests proximity to. Another implementation of module 230 also assigns a workspace according to a type of workspace a user has previously requested or has chosen most frequently.

Temperature management module 240 uses a building management system to measure an ambient temperature of the workspace, and adjust an ambient temperature of the workspace during the time period specified in one or more workspace assignments. Temperature management module 240 uses workspace booking requests and a building management system to minimize adjustments of an ambient temperature of workspaces within a building. For example, natural heating due to the sun or rising heat might mean that an upper floor is naturally warmer than a lower floor of a building, and thus module 240 might assign those who prefer a warmer environment to the upper floor and those who prefer a cooler environment to the lower floor. As another example, natural heating due to the sun might mean that a building area exposed to the sun is naturally warmer than a building area that is not exposed to the sun, and thus module 240 might assign those who prefer a warmer environment to the sunny area, during times when the area is exposed to the most sunlight, and those who prefer a cooler environment to an area exposed to less sunlight, and adjust workspace assignment according to the sun's movement during the day. As another example, if there are fewer workspace requests than workspaces in a building, module 240 might group the assigned workspaces into one area of a building, and adjust ambient temperatures in unoccupied portions of the building to temperatures lower-than-preferred (in the winter) or higher-than-preferred (in the summer) to conserve energy.

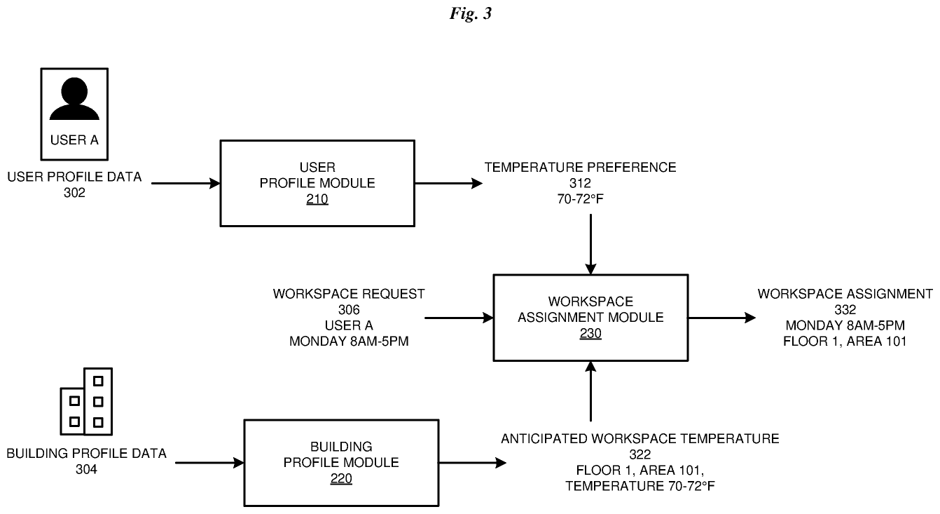

With reference to FIG. 3, this figure depicts an example of environmental condition based workspace assignment in accordance with an illustrative embodiment. User profile module 210, building profile module 220, and workspace assignment module 230 are the same as user profile module 210, building profile module 220, and workspace assignment module 230 in FIG. 2. The example can be executed using application 200 in FIG. 2.

User profile module 210 receives user profile data 302 for User A, and generates a user profile for User A, including temperature preference 312. Building profile module 220 receives building profile data 304 for a building in which User A intends to work, and generates a building profile, including anticipated workspace temperature 322. Workspace assignment module 230 receives workspace request 306 for User A, and uses temperature preference 312 and anticipated workspace temperature 322 to generate workspace assignment 332-a workspace in which the ambient temperature is predicted to match User A's preferred temperature range.

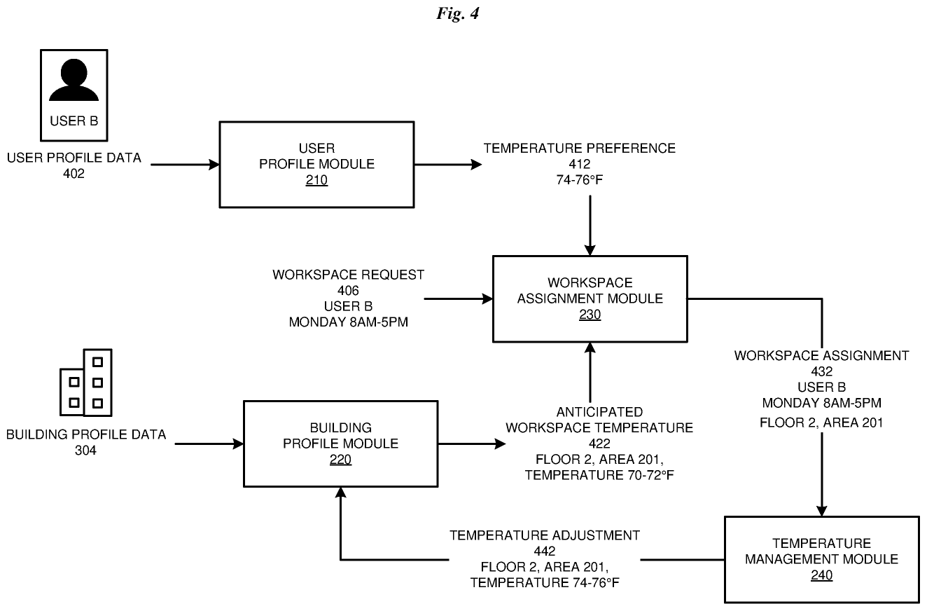

With reference to FIG. 4, this figure depicts a continued example of environmental condition based workspace assignment in accordance with an illustrative embodiment. User profile module 210, building profile module 220, workspace assignment module 230, and temperature management module 240 are the same as user profile module 210, building profile module 220, workspace assignment module 230, and temperature management module 240 in FIG. 2. Building profile data 304 is the same as building profile data 304 in FIG. 3.

User profile module 210 receives user profile data 402 for User B, and generates a user profile for User B, including temperature preference 412. Building profile module 220 receives building profile data 304 for a building in which User B intends to work, and generates a building profile, including anticipated workspace temperature 422. Workspace assignment module 230 receives workspace request 406 for User B, and uses temperature preference 412 and anticipated workspace temperature 422 to generate workspace assignment 432. Because area 101 of Floor 1 has an ambient temperature in the 70-72° F. range, and hot air rises, it will be efficient to set area 201 of Floor 2, directly above area 101 of Floor 1, to 74-76° F. Thus module 230 assigns (in workspace assignment 432) User B to a workspace in area 201 of Floor 2, and temperature management module 240 performs temperature adjustment 442, which adjusts an ambient temperature of the workspace to 74-76° F. all day on Monday. Temperature adjustment 442 is also fed back into building profile module 220, for use in updating the building profile.

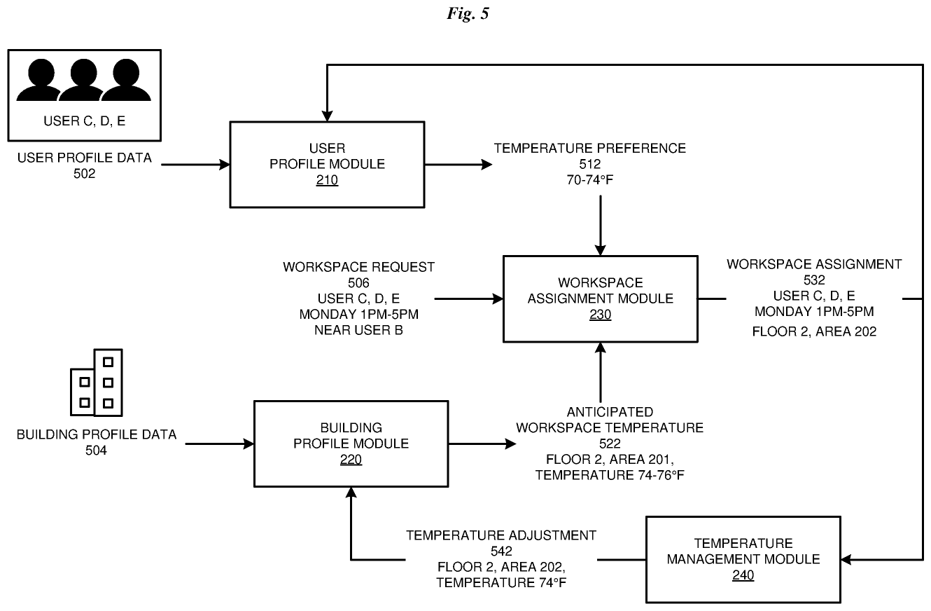

With reference to FIG. 5, this figure depicts a continued example of environmental condition based workspace assignment in accordance with an illustrative embodiment. User profile module 210, building profile module 220, workspace assignment module 230, and temperature management module 240 are the same as user profile module 210, building profile module 220, workspace assignment module 230, and temperature management module 240 in FIG. 2.

User profile module 210 receives user profile data 502 for Users C, D, and E, a team, and generates temperature preference 512, an overall preference for the team . . . Building profile module 220 receives building profile data 504 and generates a building profile, including anticipated workspace temperature 522. Workspace assignment module 230 receives workspace request 506 requesting workspaces for Monday afternoon, near each other and near User B. Workspace assignment module 230 uses temperature preference 512 and anticipated workspace temperature 522 to generate workspace assignment 532. Because area 201 of Floor 2, where User B will be, is already set to an ambient temperature of 74-76° F. all day on Monday, it will be efficient to assign Users C. D. and E to workspaces in area 202 of Floor 2, next to area 201, and adjust an ambient temperature of the workspaces to 74° F. (thus satisfying Users C, D, and E while not discommoding User B and other users who prefer the 74-76° F. of nearby workspaces). Thus module 230 assigns (in workspace assignment 532) Users C, D, and E to a workspace in area 202 of Floor 2, and temperature management module 240 performs temperature adjustment 542, which adjusts an ambient temperature of the workspace to 74° F. Monday afternoon. Temperature adjustment 542 is also fed back into building profile module 220, for use in updating the building profile. Workspace assignment 532 is also fed back into user profile module 210, so that Users C, D, and E's request to be near User B can be used in updating the users' profiles.

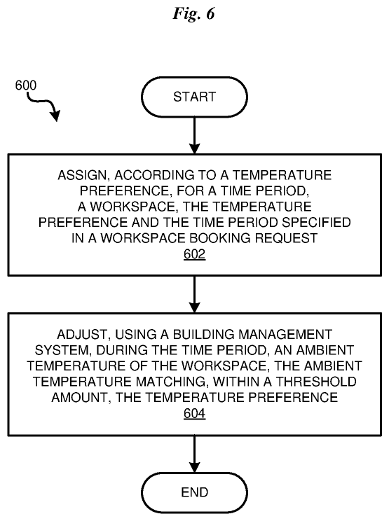

With reference to FIG. 6, this figure depicts a flowchart of an example process for environmental condition based workspace assignment in accordance with an illustrative embodiment. Process 600 can be implemented in application 200 in FIG. 2.

In block 602, the application assigns, according to a temperature preference, for a time period, a workspace, the temperature preference and the time period specified in a workspace booking request. In block 604, the application adjusts, using a building management system, during the time period, an ambient temperature of the workspace, the ambient temperature matching, within a threshold amount, the temperature preference. Then the application ends.

Thus, a computer implemented method, system or apparatus, and computer program product are provided in the illustrative embodiments for environmental condition based workspace assignment and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

What is claimed is:

1. A computer-implemented method comprising:
assigning, according to a temperature preference, for a time period, a workspace, the temperature preference and the time period specified in a workspace booking request; and
adjusting, using a building management system, during the time period, an ambient temperature of the workspace, the adjusting resulting in the ambient temperature matching, within a threshold amount, the temperature preference.

2. The computer-implemented method of claim 1, wherein the temperature preference is extracted from a user profile, the user profile determined from a plurality of past workspace booking requests of a user.

3. The computer-implemented method of claim 1, further comprising:
assigning, according to the temperature preference, for the time period, a second workspace, the second workspace assigned based on proximity to the workspace.

4. The computer-implemented method of claim 1, further comprising:
assigning, according to a third temperature preference, for the time period, a third workspace, the third workspace assigned to minimize adjustment of an ambient temperature of the third workspace during the time period.

5. The computer-implemented method of claim 1, further comprising:
assigning, according to a fourth temperature preference, for the time period, a fourth workspace, the fourth workspace assigned based on an anticipated ambient temperature of the fourth workspace during the time period.

6. The computer-implemented method of claim 1, further comprising:
assigning, according to a fifth temperature preference, for the time period, a fifth workspace, the fifth workspace assigned to group a plurality of building occupants into an occupied portion of a building.

7. The computer-implemented method of claim 6, wherein the fifth workspace is assigned using a building usage pattern.

8. A computer program product comprising one or more computer readable storage medium, and program instructions collectively stored on the one or more computer readable storage medium, the program instructions executable by a processor to cause the processor to perform operations comprising:
assigning, according to a temperature preference, for a time period, a workspace, the temperature preference and the time period specified in a workspace booking request; and
adjusting, using a building management system, during the time period, an ambient temperature of the workspace, the adjusting resulting in the ambient temperature matching, within a threshold amount, the temperature preference.

9. The computer program product of claim 8, wherein the stored program instructions are stored in a computer readable storage device in a data processing system, and wherein the stored program instructions are transferred over a network from a remote data processing system.

10. The computer program product of claim 8, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

11. The computer program product of claim 8, wherein the temperature preference is extracted from a user profile, the user profile determined from a plurality of past workspace booking requests of a user.

12. The computer program product of claim 8, further comprising:
assigning, according to the temperature preference, for the time period, a second workspace, the second workspace assigned based on proximity to the workspace.

13. The computer program product of claim 8, further comprising:
assigning, according to a third temperature preference, for the time period, a third workspace, the third workspace assigned to minimize adjustment of an ambient temperature of the third workspace during the time period.

14. The computer program product of claim 8, further comprising:
assigning, according to a fourth temperature preference, for the time period, a fourth workspace, the fourth workspace assigned based on an anticipated ambient temperature of the fourth workspace during the time period.

15. The computer program product of claim 8, further comprising:
assigning, according to a fifth temperature preference, for the time period, a fifth workspace, the fifth workspace assigned to group a plurality of building occupants into an occupied portion of a building.

16. The computer program product of claim 15, wherein the fifth workspace is assigned using a building usage pattern.

17. A computer system comprising a processor and one or more computer readable storage media, and program instructions collectively stored on the one or more computer readable storage media, the program instructions executable by the processor to cause the processor to perform operations comprising:
assigning, according to a temperature preference, for a time period, a workspace, the temperature preference and the time period specified in a workspace booking request; and
adjusting, using a building management system, during the time period, an ambient temperature of the workspace, the adjusting resulting in the ambient temperature matching, within a threshold amount, the temperature preference.

18. The computer system of claim 17, wherein the temperature preference is extracted from a user profile, the user profile determined from a plurality of past workspace booking requests of a user.

19. The computer system of claim 17, further comprising:
assigning, according to the temperature preference, for the time period, a second workspace, the second workspace assigned based on proximity to the workspace.

20. The computer system of claim 17, further comprising:
assigning, according to a third temperature preference, for the time period, a third workspace, the third workspace assigned to minimize adjustment of an ambient temperature of the third workspace during the time period.

21. The computer system of claim 17, further comprising:
assigning, according to a fourth temperature preference, for the time period, a fourth workspace, the fourth workspace assigned based on an anticipated ambient temperature of the fourth workspace during the time period.

22. The computer system of claim 17, further comprising:
assigning, according to a fifth temperature preference, for the time period, a fifth workspace, the fifth workspace assigned to group a plurality of building occupants into an occupied portion of a building.

23. The computer system of claim 22, wherein the fifth workspace is assigned using a building usage pattern.

24. A computing environment comprising:
a shared pool of configurable computing resources;
at least one data processing system included in the configurable computing resources, the at least one data processing system comprising a processor unit and a data storage unit;
a service delivery model to deliver on-demand access to the shared pool of resources;
a metering capability to measure a service delivered via the service delivery model; and
program instructions collectively stored on one or more computer readable storage media, the program instructions executable by the processor unit to cause the processor unit to perform operations comprising:
assigning, according to a temperature preference, for a time period, a workspace, the temperature preference and the time period specified in a workspace booking request; and
adjusting, using a building management system, during the time period, an ambient temperature of the workspace, the adjusting resulting in the ambient temperature matching, within a threshold amount, the temperature preference.

25. A software service delivery architecture comprising:
a shared pool of configurable computing resources;
at least one data processing system included in the shared pool of configurable computing resources, the at least one data processing system comprising a processor unit and a data storage unit;
at least one data networking component configured to enable data communication with the at least one data processing system;
an application control mechanism to execute a software application that is deployed to execute using the at least one data processing system; and
program instructions of the software application, wherein the program instructions are executable by the processor unit to cause the processor unit to perform operations comprising:
assigning, according to a temperature preference, for a time period, a workspace, the temperature preference and the time period specified in a workspace booking request; and
adjusting, using a building management system, during the time period, an ambient temperature of the workspace, the adjusting resulting in the ambient temperature matching, within a threshold amount, the temperature preference.
